(19) United States
(12) Patent Application Publication
(10) Pub. No.: US 2021/0142188 A1
(43) Pub. Date: May 13, 2021

(54) DETECTING SCENES IN INSTRUCTIONAL VIDEO

(71) Applicant: INTERNATIONAL BUSINESS MACHINES CORPORATION, ARMONK, NY (US)

(72) Inventors: Sally L. Howard, Eastleigh (GB); Timothy Andrew Moran, Southampton (GB); Katherine Rose Farmer, Eastleigh (GB); Emma Jane Dawson, Eastleigh (GB)

(21) Appl. No.: 16/681,886

(22) Filed: Nov. 13, 2019

(51) Int. Cl. G06N 5/04; G06F 16/783; G06N 20/00; G09B 5/06

(52) U.S. Cl. CPC G06N 5/04; G09B 5/06; G06N 20/00; G06F 16/784

(57) ABSTRACT

Detecting a scene in an instructional video is presented. One example includes analyzing the visual and/or audio content of the instructional video to identify instances of indicative behavior of the instructor, an instance of indicative behavior being identified based on the presence of at least one of a set of predetermined behavioral patterns of the instructor in the visual and/or audio content of the instructional video. A scene in the instructional video is then detected based on the identified instances of indicative behavior of the instructor.

### BACKGROUND

The present invention relates generally to video processing, and more particularly to detecting scenes in instructional video comprising instructional content conveyed by an instructor.

Instructional video comprising instructional content conveyed by an instructor is typically presented as a single continuous video that describes multiple different sections of a process (e.g. different method steps or stages) in sequence. A viewer (i.e. consumer) of instructional content normally desires to digest the different sections of content at his/her own pace, particularly in the case of a sequence of complicated steps that must be followed accurately. This can create difficulties for the viewer when following along with each section takes longer than the time taken in the video to explain or demonstrate the sections. It is therefore common for a viewer to have to repeatedly re-watch an instructional video, requiring the viewer to rewind/reverse through the continuous video and attempt to restart the video at appropriate points. This can be difficult and frustrating for the viewer to do, especially for a single continuous video that describes multiple different sections of a process.

### SUMMARY

Embodiment of the present invention provide a computer program product comprising computer-readable program code that enables a processor of a system, or a number of processors of a network, to implement such a method.

Embodiments of the present invention further provide a computer system comprising at least one processor and such a computer program product, wherein the at least one processor is adapted to execute the computer-readable program code of said computer program product.

Embodiments of the present invention provide a system for detecting scenes in instructional video comprising instructional content conveyed by an instructor.

The present invention seeks to provide a method for detecting scenes in instructional video comprising instructional content conveyed by an instructor. Such a method may be computer-implemented.

The present invention further seeks to provide a computer program product including computer program code for implementing a proposed method when executed by a processing unit.

The present invention also seeks to provide a processing system adapted to execute this computer program code.

The present invention also seeks to provide a system for detecting scenes in instructional video comprising instructional content conveyed by an instructor.

According to an aspect of the present invention, there is provided a computer-implemented method for detecting scenes in instructional video comprising instructional content conveyed by an instructor. The method comprises analyzing the visual and/or audio content of the instructional video to identify instances of indicative behavior of the instructor, an instance of indicative behavior being identified based on the presence of at least one of a set of predetermined behavioral patterns of the instructor in the visual and/or audio content of the instructional video. The method also comprises detecting a scene in the instructional video based on the identified instances of indicative behavior of the instructor.

According to another aspect of the invention, there is provided a computer program product for detecting a scene transition in video footage. The computer program product comprises a computer readable storage medium having program instructions embodied therewith, the program instructions executable by a processing unit to cause the processing unit to perform a method according to a proposed embodiment.

According to another aspect of the invention, there is provided a processing system comprising at least one processor and the computer program product according to an embodiment. The at least one processor is adapted to execute the computer program code of said computer program product.

According to yet another aspect of the invention, there is provided a system for detecting scenes in instructional video comprising instructional content conveyed by an instructor. The system comprises an analysis component configured to analyze the visual and/or audio content of the instructional video to identify instances of indicative behavior of the instructor, an instance of indicative behavior being identified based on the presence of at least one of a set of predetermined behavioral patterns of the instructor in the visual and/or audio content of the instructional video. The system also comprises a scene detection component configured to detect a scene in the instructional video based on the identified instances of indicative behavior of the instructor.

### BRIEF DESCRIPTION OF THE DRAWINGS

Preferred embodiments of the present invention will now be described, by way of example only, with reference to the following drawings, in which:

FIG. 1 is a block diagram of an example system in which aspects of the illustrative embodiments may be implemented;

FIG. 2 is a simplified block diagram of an exemplary embodiment of a system for detecting a scene in instructional video comprising instructional content conveyed by an instructor;

FIGS. 3A-3E depicts an example of instructional video demonstrating how to draw a line using a graphics tool, wherein each illustrates a respective part of the instructional video where a proposed embodiment would identify scene; and

FIG. 4 is a simplified block diagram of an exemplary embodiment of a system for detecting a scene for detecting a scene in instructional video.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method may be a process for execution by a computer, i.e. may be a computer-implementable method. The various steps of the method may therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

Embodiments of the present invention detect scenes in instructional video comprising instructional content. In particular, a scene in instructional video footage may be detected based on behavior of the instructor conveying the instructional content. Put another way, identifying the presence of a behavioral pattern of the instructor in the visual and/or audio content of the instructional video may be used to detect a scene in the instructional video.

Embodiments of the present invention may provide for dividing an instructional video into scenes that each include one or more video frames. For instance, a method instruction video may be automatically split into shorter video segments, whereby each video segment relates to a different section or step of the instructed method. Such automatic splitting may be based on detecting indicative behavior of the instructor that is suggestive of a start and/or end of a section or step of the instructed method.

The video and/or audio content of an instructional video can be analyzed to identify the presence of at least one of a set of predetermined behavioral patterns of the instructor. The identification of one or more such behavioral patterns may be used to infer or identify the presence of a transition/change in the instructed content. This may thus be provided as extension to existing video processing processes/algorithms.

The analysis and automated splitting may remove a need for manual human splitting and/or time-stamping of instructional videos (which is current practice for many conventional methods). Also, the analysis and automated splitting may be integrated with a known process/algorithm for detecting scenes, thereby increasing the robustness and/or improving the accuracy of that process/algorithm. The analysis and automated splitting may also be implemented alongside existing scene detection systems.

In an embodiment, visual and/or audio content of an instructional video can be analyzed in order to detect instances of indicative behavior of the instructor. For instance, a sequence of words spoken by the instructor may be detected to identify transitions in scene transitions in a relatively straight-forward manner.

Machine-learning can determine behavioral patterns of an instructor that are indicative of a change in instructional content. In this way, (un-supervised or supervised) learning concepts may be leveraged to improve detection of behavioral patterns of an instructor that are indicative of a change in instructional content.

By way example, one or more behavioral patterns of an instructor in visual and/or audio content of an instructional video may be identified which are indicative of a change in scene of the instructional video. The start and/or end of sections of instructional content (i.e. a scene) may therefore be identified based on detecting instances of such indicative behavior of the instructor. Embodiments may thus provide the advantage that they can be retrospectively applied to pre-existing instructional videos that have not previously had scenes identified. This may create significant value in legacy media resources. Various embodiments of the present invention may also allow newly-created instructional video to be automatically sub-divided, without requiring manual tagging by the content creator (thus saving time and enabling a more natural method of content creation for the creator).

The functionality of video processing algorithms may be modified and supplemented. For instance, new or additional scene detection algorithms can be integrated into existing video processing systems. Thus, improved or extended functionality to existing video processing implementations can be provided. Leveraging information about detected behavior of the instructor in instructional video to provide scene detection functionality can therefore increase the value of a video processing system.

Some proposed embodiments may further comprise processing a sample video comprising instructional content conveyed by the instructor with a machine learning algorithm to identify a behavioral pattern of the instructor in the visual and/or audio content of the instructional video, the identified behavioral pattern being indicative of the beginning or end of a section of the instructional content. Also, the identified behavioral pattern may then be included in the set of predetermined behavioral patterns. In an embodiment, the instructional video may comprise the sample video. Accordingly, behavioral patterns of the instructor (which may be indicative of the beginning or end of a section of the instructional content) may be learnt from a sample video, and such a sample video may or may not comprise the instructional video to which scene detection is being employed. Some embodiments may therefore leverage a large collection of other videos of the instructor (such as old/legacy videos) in order to identify behavioral patterns of the instructor indicative of the beginning or end of a section of the instructional content. However, various embodiments may support the instructional video itself being analyzed to identify behavioral patterns of the instructor that are indicative of changes in instructional content. Therefore, learning from a wide/large range of video sources is supported, thus facilitating improved learning and improved scene detection.

By way of example, a predetermined behavioral pattern of the set of predetermined behavioral patterns may comprise at least one of: a word or sequence of words spoken by the instructor; a movement of the instructor; a pose or gesture of the instructor; a change in an object in the video controlled by the instructor; a pattern of movement of an object in the video controlled by the instructor; and a variation in pitch or tone of speech of the instructor. A range of relatively simple analysis or detection techniques may thus be employed by proposed embodiments in order to detect instances of indicative behavior of the instructor that are indicative of changes in instructional content. This may help to minimize the cost and/or complexity of implementation.

Embodiments of the present invention may further comprise identifying at least one of a start and an end of the detected scene based on the identified instances of indicative behavior of the instructor. Instances of indicative behavior may be associated with the start or end of sections of instructional content. For example, a first instance of indicative behavior (such as particular phrase or expression spoken by the instructor) may be associated with the start of a new section of instruction content, i.e. a transition into a next step or stage in an instructed process. Further, a second, different instance of indicative behavior (such as particular movement or gesture performed by the instructor) may be associated with the end of section of instruction content, i.e. a transition away or out of a step or stage in an instructed process. Identification of scenes in general may be supported, as well as supporting the accurate detection of the start and/or end of scenes in instructional video.

Embodiments of the present invention may also comprise dividing the instructional video into scenes that each include one or more video frames based on the detected scene. The automatic splitting, segmenting or dividing of an instructional video may therefore be facilitated. This may, for example, enable particular scenes of instructional video to be extracted and used in isolation (i.e. separated from the original instructional video).

An embodiment may also comprise: analyzing the detected scene to generate metadata describing instructional content of the scene; and associating the generated metadata with the detected scene. In this way, embodiments may enable scenes to be described and such descriptions may be stored with (or linked to) the scenes. This may facilitate simple identification and/or searching of instructional content within instructional video.

Further exemplary embodiments may detect a scene and obtain a value of a confidence measure associated with an identified instance of indicative behavior of the instructor. The detected scene may then be confirmed based on the obtained value of the confidence measure. Simple data value comparison techniques may thus be employed to confirm accurate detection of scenes in instructional video.

FIG. 1 is a block diagram of an example system 200 in which aspects of the illustrative embodiments may be implemented. The system 200 is an example of a computer, such as client in a distributed processing system, in which computer usable code or instructions implementing the processes for illustrative embodiments of the present invention may be located. For instance, the system 200 may be configured to implement an analysis component and scene detection component according to an embodiment.

In the depicted example, the system 200 employs a hub architecture including a north bridge and memory controller hub (NB/MCH) 202 and a south bridge and input/output (I/O) controller hub (SB/ICH) 204. A processing unit 206, a main memory 208, and a graphics processor 210 are connected to NB/MCH 202. The graphics processor 210 may be connected to the NB/MCH 202 through an accelerated graphics port (AGP).

In the depicted example, a local area network (LAN) adapter 212 connects to SB/ICH 204. An audio adapter 216, a keyboard and a mouse adapter 220, a modem 222, a read only memory (ROM) 224, a hard disk drive (HDD) 226, a CD-ROM drive 230, a universal serial bus (USB) ports and other communication ports 232, and PCI/PCIe devices 234 connect to the SB/ICH 204 through first bus 238 and second bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

The HDD 226 and CD-ROM drive 230 connect to the SB/ICH 204 through second bus 240. The HDD 226 and CD-ROM drive 230 may use, for example, an integrated drive electronics (IDE) or a serial advanced technology attachment (SATA) interface. Super I/O (SIO) device 236 may be connected to SB/ICH 204.

An operating system runs on the processing unit 206. The operating system coordinates and provides control of various components within the system 200 in FIG. 2. As a client, the operating system may be a commercially available operating system. An object-oriented programming system, such as the Java™ programming system, may run in conjunction with the operating system and provides calls to the operating system from Java™ programs or applications executing on system 200.

As a server, system 200 may be a symmetric multiprocessor (SMP) system including a plurality of processors in processing unit 206. Alternatively, a single processor system may be employed.

Instructions for the operating system, the programming system, and applications or programs are located on storage devices, such as HDD 226, and may be loaded into main memory 208 for execution by processing unit 206. Similarly, one or more scene detection programs according to an embodiment may be adapted to be stored by the storage devices and/or the main memory 208.

The processes for illustrative embodiments of the present invention may be performed by processing unit 206 using computer usable program code, which may be located in a memory such as, for example, main memory 208, ROM 224, or in one or more peripheral devices 226 and 230.

A bus system, such as first bus 238 or second bus 240 as shown in FIG. 2, may comprise one or more buses. Of course, the bus system may be implemented using any type of communication fabric or architecture that provides for a transfer of data between different components or devices attached to the fabric or architecture. A communication unit, such as the modem 222 or the network adapter 212 of FIG. 1, may include one or more devices used to transmit and receive data. A memory may be, for example, main memory 208, ROM 224, or a cache such as found in NB/MCH 202 in FIG. 1.

Those of ordinary skill in the art will appreciate that the hardware in FIG. 1 may vary depending on the implementation. Other internal hardware or peripheral devices, such as flash memory, equivalent non-volatile memory, or optical disk drives and the like, may be used in addition to or in place of the hardware depicted in FIG. 1. Also, the processes of the illustrative embodiments may be applied to a multiprocessor data processing system, other than the system mentioned previously, without departing from the scope of the present invention.

Moreover, the system 200 may take the form of any of a number of different data processing systems including client computing devices, server computing devices, a tablet computer, laptop computer, telephone or other communication device, a personal digital assistant (PDA), or the like. In some illustrative examples, the system 200 may be a portable computing device that is configured with flash memory to provide non-volatile memory for storing operating system files and/or user-generated data, for example. Thus, the system 200 may essentially be any known or later-developed data processing system without architectural limitation.

Referring now to FIG. 2, there is depicted a simplified block diagram of an exemplary embodiment of system 200 for detecting a scenes in instructional video footage 210.

The system 200 comprises an interface component 220 configured to obtain instructional video 210 comprising instructional content conveyed by an instructor. By way of example, the instructional video 210 may be provided directly to the system by a user, or from another system (such as a conventional video processing system (not shown)).

The system 200 for detecting scenes in instructional video footage 210 also comprises an analysis component 230. The analysis component 230 analyzes the visual and/or audio content of the instructional video to identify instances of indicative behavior of the instructor. Here, an instance of indicative behavior is identified based on the presence of a behavioral pattern of the instructor in the visual and/or audio content of the instructional video. By way of example, such a behavioral pattern may be one of a set of predetermined behavioral patterns that are indicative of a change in instructional content. For instance, the set of behavioral patterns may comprise: a word or sequence of words spoken by the instructor; a movement of the instructor; a pose or gesture of the instructor; a change in an object in the video controlled by the instructor; a pattern of movement of an object in the video controlled by the instructor; and a variation in pitch or tone of speech of the instructor.

Behavioral patterns that are indicative of a change in instructional content may be identified by the system 200 using sample videos. To improve accuracy, such sample videos may comprise the same instructor as that of the instructional video 210 received via the interface 220. For such learning, the system 200 comprises a processor 240.

The processor 240 processes a sample video comprising instructional content conveyed by the instructor. In this example, the processing employ a machine learning algorithm to identify a behavioral pattern of the instructor in the visual and/or audio content of the instructional video. Put another way, the processor 240 implements a machine learning technique to identified behavioral patterns that are indicative of the beginning or end of a section of the instructional content. Such identified behavioral patterns are then added to the set of predetermined behavioral patterns that are indicative of a change in instructional content. In this way, the set of predetermined behavioral patterns may be tailored to the specific behavioral characteristics of the instructor of the instructional video.

A scene detection component 250 of the system 200 detects a scene in the instructional video based on instances of indicative behavior of the instructor that have been identified by the analysis component 230. Further, the scene detection component 250 also identifies the start and/or end of the detected scene(s) based on the identified instances of indicative behavior of the instructor.

A video processor 260 of the system 200 is then configured to divide the instructional video into scenes that each include one or more video frames based on the detected scene(s). To supplement this, the system 200 also comprises a content analysis component 270 that analyzes the detected scene(s) to generate metadata describing instructional content of the scene. The content analysis component 270 then associates the generated metadata with the detected scene(s). For example, generated metadata is stored with the respective scene(s).

From the above description of proposed embodiments, it will be understood that there may be provided a system/method that uses machine learning to split instructional video into scenes that each relate to difference sections/stages of instructional content. A user or viewer of the instructional video may then easily identify and skip between scenes of the instructional video. In particular, it is proposed that scenes in instructional video can be detected by identifying instances of indicative behavior of the instructor, such indicative behavior being indicative of changes in the instructional content.

Embodiments may therefore use a combination of voice, video and image recognition to tag recurring ‘signature’ behaviours that may indicate the start or end of a process/method step within the instructional video.

For example, timing of the presenter appearing in the video and/or certain sentences spoken by the presenter may be detected and timestamped to infer changes in instructional content. Also, the position of user interface elements (e.g. mouse pointers) may be detected and monitored to identify instructor behaviour and infer changes in instructional content.

Further, a user may train the system as to where scenes begin and/or end. For example, a user may watch representative samples of the instructional video and indicate timestamps at which method steps of an instructed process begin. Embodiments may then use machine learning to associate the start of the steps with signature behaviour(s) of the instructor.

A confidence weighting may also be applied to each signature to indicate its likelihood of indicating the start of an instructed method/process step. For example, if an instructor always uses a particular phrase (or one of a set of phrases) to introduce the start of new process/method step, then a high confidence weighting may be associated with a timestamp associated with detected instances of the phrase.

Other exemplary behaviour that may indicate a scene change may include: change in backdrop; change in appearance of instructor (e.g. videos that alternate between a presenter talking to camera when introducing a step followed by a demonstration of that step which does not feature the presenter); position of a pointer on screen (e.g. a new instructed step may always starts with selection of a tool or menu item from a particular area of the video content); consistent sequences of cuts or camera angles; and text appearing in the video.

When sufficient training has been provided, embodiments may apply learned rules to automatically split instructional video content into constituent steps.

It will be appreciated the proposed embodiments may employ the idea that automatic identification of scenes in an instructional video can be based on detecting particular behavior(s) of an instructor of the video. Such behavior(s) may be indicative of changes in instructed content and thus also indicative of scene changes.

By way of yet further illustration of proposed concepts, an example will now be described with reference to FIGS. 3A-3E which depict an instructional video to demonstrate how to draw a line using a graphics tool.

FIGS. 3A-3E illustrate the various parts of the instructional video where a proposed embodiment would identify a scene.

The example uses the following indicative behaviors of the instructor:
Repeated key phrases used by the presented in the video example are: ‘and’, ‘you’ & ‘now’;
Repeated movement behavior in the video content in the video example such as: mouse/cursor significantly moving across screen, and the mouse/cursor drawing lines;
Pauses are significant—the instructor naturally pauses to wait for the viewer to catch up/absorb what they have shown. Pauses are longer between sections;
The instructor naturally speaks more slowly if they are moving the mouse around doing something on screen, not only for emphasis but because they are concentrating on their actions rather than what they are saying;
Common or repeated phrases may indicate the viewer needs to do something. You would want to insert a pause before each one, to allow the viewer to complete the previous step. Example phrases start with ‘you’, e.g. “You can . . . ”, “you see . . . ”. Also, clauses starting with ‘and’, ‘also’, e.g. “and by doing this”, “we can also”; Commands, e.g. “do this”, “you can”, “let's.”; Demonstrative phrases, e.g. “by selecting”, “by using”; Time phrases, e.g. “now”, “after that”; Phrases which signify direction/movement, e.g. “I go over here to”; and Computer user specific: click, select, hold, press, enter, move, mouse, menu, key, type, e.g. “click on that”
Cadence, emphasis and volume of voice may signify a change in instructional content. For example: raising volume to build towards a point; changing volume when changing an idea; slowing the pace to emphasize important bits; affirmative statements should end with a level or slightly lower pitch.

Observations include: instructional videos are generally split into sections. A first section demonstrates the basics of the process/method at a slower pace. A second section then demonstrates extensions or other things that can be done.

From the above description, it will be appreciated that proposed embodiments may infer a transition in instructional content conveyed by an instructor of an instructional video. Such inference may be achieved by detecting a predetermined behavioral pattern of the instructor. For instance, a change in an object controlled by the instructor or a pattern of movement of an object controlled by the instructor may indicate the beginning or end of a section of instructional content. Further, a start and/or end point of the section of instructional content may be identified based on the frames for which the behavioral pattern is detected.

By way of further example, as illustrated in FIG. 4, embodiments may comprise a computer system 70, which may form part of a networked system 7. For instance, a system for detecting scenes in instructional video may be implemented by the computer system 70. The components of computer system/server 70 may include, but are not limited to, one or more processing arrangements, for example comprising processors or processing units 71, a system memory 74, and a bus 90 that couples various system components including system memory 74 to processing unit 71.

System memory 74 can include computer system readable media in the form of volatile memory, such as random access memory (RAM) 75 and/or cache memory 76. Computer system/server 70 may further include other removable/non-removable, volatile/non-volatile computer system storage media. In such instances, each can be connected to bus 90 by one or more data media interfaces. The memory 74 may include at least one program product having a set (e.g., at least one) of program modules that are configured to carry out the functions of proposed embodiments. For instance, the memory 74 may include a computer program product having program executable by the processing unit 71 to cause the system to perform, a method for detecting scenes in instructional video according to a proposed embodiment.

Program/utility 78, having a set (at least one) of program modules 79, may be stored in memory 74. Program modules 79 generally carry out the functions and/or methodologies of proposed embodiments for detecting a scene instructional video.

Computer system/server 70 may also communicate with one or more external devices 80 such as a keyboard, a pointing device, a display 85, etc.; one or more devices that enable a user to interact with computer system/server 70; and/or any devices (e.g., network card, modem, etc.) that enable computer system/server 70 to communicate with one or more other computing devices. Such communication can occur via Input/Output (I/O) interfaces 72. Still yet, computer system/server 70 can communicate with one or more networks such as a local area network (LAN), a general wide area network (WAN), and/or a public network (e.g., the Internet) via network adapter 73 (e.g. to communicate recreated content to a system or user).

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for detecting scenes in instructional video comprising instructional content conveyed by an instructor, the method comprising:
analyzing a visual and/or audio content of an instructional video to identify instances of indicative behavior of the instructor, an instance of indicative behavior being identified based on a presence of at least one of a set of predetermined behavioral patterns of the instructor in the visual and/or audio content of the instructional video; and
detecting a scene in the instructional video based on the identified instances of indicative behavior of the instructor.

2. The method of claim 1, further comprising:
processing a sample video comprising instructional content conveyed by the instructor with a machine learning algorithm to identify a behavioral pattern of the instructor in the visual and/or audio content of the instructional video, the identified behavioral pattern being indicative of a beginning or an end of a section of the instructional content; and
including the identified behavioral pattern in the set of predetermined behavioral patterns.

3. The method of claim 2, wherein the instructional video comprises the sample video.

4. The method of claim 1, wherein a predetermined behavioral pattern of the set of predetermined behavioral patterns comprises at least one of:
a word or sequence of words spoken by the instructor;
a movement of the instructor;
a pose or gesture of the instructor;
a change in an object in the video controlled by the instructor;
a pattern of movement of an object in the video controlled by the instructor; and
a variation in pitch or tone of speech of the instructor.

5. The method of claim 1, further comprising:
identifying at least one of a start and an end of the detected scene based on the identified instances of indicative behavior of the instructor.

6. The method of claim 1, further comprising:
based on the detected scene, dividing the instructional video into scenes that each include one or more video frames.

7. The method of claim 1, further comprising:
analyzing the detected scene to generate metadata describing instructional content of the scene; and
associating the generated metadata with the detected scene.

8. The method of claim 1, further comprising:
for the detected scene, obtaining a value of a confidence measure associated with an identified instance of indicative behavior of the instructor; and
confirming the detected scene based on the obtained value of the confidence measure.

9. A computer program product comprising a computer readable storage medium having program instructions embodied therewith, the program instructions executable by a processing unit to cause the processing unit to perform, when run on a computer network, a method for detecting scenes in instructional video comprising instructional content conveyed by an instructor, wherein the method comprises the steps of:
analyzing a visual and/or audio content of an instructional video to identify instances of indicative behavior of the instructor, an instance of indicative behavior being identified based on a presence of at least one of a set of predetermined behavioral patterns of the instructor in the visual and/or audio content of the instructional video; and
detecting a scene in the instructional video based on the identified instances of indicative behavior of the instructor.

10. The computer program product of claim 9, further comprising:
processing a sample video comprising instructional content conveyed by the instructor with a machine learning algorithm to identify a behavioral pattern of the instructor in the visual and/or audio content of the instructional video, the identified behavioral pattern being indicative of a beginning or an end of a section of the instructional content; and
including the identified behavioral pattern in the set of predetermined behavioral patterns.

11. The computer program product of claim 9, wherein the instructional video comprises the sample video.

12. The computer program product of claim 9, further comprising:
analyzing the detected scene to generate metadata describing instructional content of the scene; and
associating the generated metadata with the detected scene.

13. A computer system for detecting scenes in instructional video comprising instructional content conveyed by an instructor, the system comprising one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system performs a method comprising:
analyzing a visual and/or audio content of an instructional video to identify instances of indicative behavior of the instructor, an instance of indicative behavior being identified based on a presence of at least one of a set of predetermined behavioral patterns of the instructor in the visual and/or audio content of the instructional video; and
detecting a scene in the instructional video based on the identified instances of indicative behavior of the instructor.

14. The computer system of claim 13, further comprising:
processing a sample video comprising instructional content conveyed by the instructor with a machine learning algorithm to identify a behavioral pattern of the instructor in the visual and/or audio content of the instructional video, the identified behavioral pattern being indicative of a beginning or an end of a section of the instructional content,
and wherein the analysis component includes the identified behavioral pattern in the set of predetermined behavioral patterns.

15. The computer system of claim 14, wherein the instructional video comprises the sample video.

16. The computer system of claim 13, wherein a predetermined behavioral pattern of the set of predetermined behavioral patterns comprises at least one of:
a word or sequence of words spoken by the instructor;
a movement of the instructor;
a pose or gesture of the instructor;
a change in an object in the video controlled by the instructor;
a pattern of movement of an object in the video controlled by the instructor; and
a variation in pitch or tone of speech of the instructor.

17. The computer system of claim 13, wherein a scene detection component identifies at least one of a start and an end of the detected scene based on the identified instances of indicative behavior of the instructor.

18. The computer system of claim 13, further comprising:
dividing the instructional video into scenes that each include one or more video frames based on the detected scene.

19. The computer system of claim 13, further comprising:
analyzing the detected scene to generate metadata describing instructional content of the scene and to associate the generated metadata with the detected scene.

20. The computer system of claim 13, further comprising:
obtaining, for the detected scene, a value of a confidence measure associated with an identified instance of indicative behavior of the instructor,
and confirming the detected scene based on the obtained value of the confidence measure.
